(19) United States
(12) Patent Application Publication
(10) Pub. No.: US 2025/0103834 A1
(43) Pub. Date: Mar. 27, 2025

(54) MACHINE READABLE INFORMATIONAL TAGS ASSOCIATING DIGITAL CONTENT TO INDIVIDUAL PHYSICAL ARTICLES

(71) Applicant: Canvus, Inc., Rocky River, OH (US)

(72) Inventors: Kayla Kowalski, Westlake, OH (US); Parker Kowalski, Cleveland, OH (US)

(21) Appl. No.: 18/517,767

(22) Filed: Nov. 22, 2023

Related U.S. Application Data
(60) Provisional application No. 63/540,152, filed on Sep. 25, 2023.
(60) Provisional application No. 63/409,332, filed on Sep. 23, 2022.

(51) Int. Cl. G06K 7/14

(52) U.S. Cl. CPC G06K 7/1417

(57) ABSTRACT

Systems and methods that associate a physical article with unique digital content solely associated with that physical article are discussed. The digital content can be accessed via a machine readable informational tag uniquely associated with the physical article. One example embodiment is a non-transitory machine readable medium, comprising instructions, wherein the instructions, when executed, cause a machine to: receive a request for digital content, wherein the digital content is uniquely associated with a physical article; determine one or more parties associated with the physical article; for each party of the one or more parties, determine associated content for that party for the physical article; and dynamically generate the digital content for the physical article based on the associated content determined for each party of the one or more parties.

### CROSS-REFERENCE TO RELATED APPLICATION

This application claims the benefit of U.S. Provisional Patent Applications No. 63/409,332, filed Sep. 23, 2022 and No. 63/540,152, filed Sep. 25, 2023, both of which are hereby incorporated by reference within the presented disclosure in their entireties and for all purposes.

### FIELD OF DISCLOSURE

The disclosure relates generally to machine-readable informational tags on articles. The machine-readable informational tags can be configured to link to content provided by multiple parties, for example, content provided by the article manufacturer and optionally to supplemental content provided by additional parties.

### BACKGROUND

Machine-readable informational tags can be scanned to provide information to a reader using either dedicated devices or, increasingly, a smartphone having the appropriate hardware or software. Examples of machine-readable informational tags include quick response codes (“QR codes”), near field communication tags (“NFC tags”), and radio-frequency identification tags (“RFID tags”) with the specific selection of each such tag varying depending upon the intended use and audience. Machine-readable informational tags are commonly used to provide information to viewers due to their low cost, small size, and ability to provide interactive content or content which could not be displayed in a traditional manner.

Generally, the information provided by scanning a machine-readable informational tag can vary between static content and dynamic updatable content. Static content is content that is unchangeable once the machine-readable informational tag is created such as a fixed block of text or an image. Dynamic updatable content is information which is updatable after production of the tag through linkage to a website or other network-hosted content. For example, a machine-readable tag with a link to a webpage can be updatable by updating the webpage after creation of the tag. Similar tags are also possible which interact with an app installed on a smartphone or other device.

Although dynamic content can be updated, known machine-readable informational tags have been limited to include only information from the original manufacturer, or operator, of the tag. For example, goods including a machine-readable informational tag typically include only information provided by the manufacturer of the goods limiting the potential audience of the tags and the value of the information provided.

Accordingly, there is a need for machine-readable informational tags, and a process for managing content on such informational tags, that is more inclusive and which can expand the audience and information relayed by the tags.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

A first example embodiment is a non-transitory machine readable medium, comprising instructions, wherein the instructions, when executed, cause a machine to: receive a request for digital content, wherein the digital content is uniquely associated with a physical article; determine one or more parties associated with the physical article; for each party of the one or more parties, determine associated content for that party for the physical article; and dynamically generate the digital content for the physical article based on the associated content determined for each party of the one or more parties.

A second example embodiment is a system, comprising: a physical article; and a physical tag associated with and proximate to the physical article, wherein the physical tag comprises a machine readable informational tag that uniquely associates digital content solely with the physical article, wherein the digital content comprises associated content from one or more parties associated with the physical article.

A third example embodiment is a system, comprising: a memory configured to store instructions; and one or more processors configured to execute the instructions to: select a template to determine digital content for a party in connection with one or more physical articles; select at least one of identification information or contact information for the party, wherein the digital content comprises the at least one of the identification information or the contact information; select text content associated with the party, wherein the digital content comprises the text content; select audiovisual content associated with the party, wherein the digital content comprises the audiovisual content; select one or more links to additional content associated with the party, wherein the digital content comprises the one or more links to additional content; and select the one or more physical articles for which the template is applied, wherein, for each physical article of the one or more physical articles, the template is applied to a unique website associated solely with that physical article.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 illustrates a diagram showing an example use case of a machine readable informational tag, according to various aspects discussed herein.

FIG. 2 illustrates a first example website generated based on content from two or more parties, according to various aspects discussed herein.

FIG. 3 illustrates a second example website generated based on content from two or more parties, according to various aspects discussed herein.

FIG. 4 illustrates a third example website generated based on content from two or more parties, according to various aspects discussed herein.

FIG. 5 illustrates a flow diagram of an example method or process of dynamically generating digital content from multiple parties in connection with a specific physical article, according to various aspects discussed herein.

FIG. 6 illustrates a flow diagram of an example method or process of selecting or editing digital content for a template to associate with one or more physical article(s), according to various aspects discussed herein.

FIG. 7 illustrates an example computing environment employable in connection with various embodiments discussed herein.

It should be noted that the drawings are diagrammatic and not drawn to scale. Relative dimensions and proportions of parts of the figures may be shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to providing digital content solely associated with a single physical article in connection with a machine readable informational tag are described herein, it should be understood that the disclosed systems, articles, and methods are not so limited and modifications may be made without departing from the scope of the present disclosure. The scope of the systems, methods, and electronic and computing devices for providing digital content associated with physical articles are defined by the appended claims, and all devices, processes, and methods that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

In various embodiments, systems and methods are discussed that can facilitate employing, managing, and/or implementing machine-readable informational tags (e.g., QR codes, NFC tags, RFID tags, etc.) with enhanced functionality as well as processes for managing and implementing such a machine-readable informational tag (also referred to herein as a “tag”). In various embodiments, machine-readable informational tags discussed herein can comprise and/or link to content (e.g., digital content on a website and/or a memory of the tag, etc.) which is provided by one or more parties, each of whom can have one or more roles, such as: an original manufacturer of the tag, an operator of the tag, a host of the content, a manufacturer of a physical article (e.g., object, etc.) associated with the tag (e.g., an article/object comprising the tag, an article to which the tag is affixed, an article on which the tag has been printed, an article near to and associated with the tag, etc.), an owner of the physical article, a sponsor of the physical article, a host of the physical article, etc. The inclusion of content from multiple parties (e.g., supplemental content in addition to content provided by an original manufacturer, or any of a variety of other combinations discussed or contemplated herein) can expand the potential audience and information relayed by the tags compared to known machine-readable informational tags.

In a first example use case, inclusion of content provided by a manufacturer of the tag and/or physical article as well as supplemental content provided by additional parties can enable the manufacturer to describe its products and goals while also allowing other parties, such as a purchaser, sponsor, and/or host of the article to explain why such products and goals conform to their own values. As one specific example of the first example use case, the article can be a bench made from recycled and/or reclaimed material (e.g., including reclaimed windmill parts, etc.) and can be associated with a tag comprising and/or linking to information provided by the manufacturer of the bench explaining its goal to reduce landfill waste while allowing a buyer, such as a city, to explain their own environmental goals. As can be appreciated, the content provided by the manufacturer and the additional parties can vary widely. For example, the machine-readable informational tag can alternatively be affixed or printed on apparel with a slogan saying “express yourself” and the additional parties can provide content expressing themselves.

In various embodiments, the machine-readable informational tags can be associated with (e.g., comprise and/or link to) content from a content host (e.g., which can in some embodiments also be a manufacturer of the tag and/or article) and one or more additional parties. In certain embodiments, the machine-readable informational tags can be associated with content from a single additional party such as the buyer of the article. However, in other embodiments, the machine-readable informational tags can be associated with content from any number of parties (e.g., a single party such as an owner; three parties such as a manufacturer, a donor, and a recipient; or four or more parties). For example, in such embodiments, an article may allow visitors to the article who interact with the informational tag to add content indicating they visited the article and/or support a project. Such added content can be made to be temporary or permanent. The one or more parties that are adding content can add content via one or more of a variety of options, such as via an application software and/or program (an app, which can include a mobile app) on a smart device (e.g., smart phone, tablet, laptop computer, etc.), computer, server, etc.; via a web portal, web-direct access, VPN connection or the like; etc.

In certain embodiments, supplemental content by one or more secondary parties can be regulated or non-regulated by one or more primary parties (e.g., the manufacturer, content host, article owner/host/sponsor, etc.). In some embodiments, the degree of regulation can be predetermined and/or selected by the one or more primary parties for individual articles and/or for groups of articles sharing one or more characteristics, such as the type of article, the intended use of the article, the type of purchaser of the article, the location of the article, etc. As a first example, for apparel being sold to the general public, there may be increased regulation wherein the supplemental content that can be added by the buyer may be limited to a selection of pre-selected messages and the system can automatically block inappropriate content. As a second example, for machine-readable informational tags sold to large institutional or governmental agencies, the supplemental content provided by the institutional or government agencies can be more, or even entirely, unregulated (e.g., based on an expectation that such institutions would self-regulate, based on different terms of purchase, etc.).

In some embodiments, supplemental content can be more directly regulated by one or more primary parties through, for example, an automatic or manual review process. In such embodiments, the one or more primary parties can choose what secondary party content is associated the machine-readable informational tags or even edit secondary party content (e.g., to ensure it is appropriate and commensurate with the values of the manufacturer, etc.). For example, a donor of a bench to a park may provide its own digital content, and additional content can be provided by one or more of a manufacturer, a content host, a recipient, one or more visitors, etc. In some embodiments, the converse can also occur, wherein a buyer, etc. can act as a primary party relative to a manufacturer, etc. as secondary party/parties, being able to edit most, or even all, of the content, including the content provided by the manufacturer, etc. For example, a purchaser of an article of clothing, sticker, etc. may also receive content rights in a website uniquely associated with that specific item, wherein the website can have any of a variety of default content (e.g., content provided by a manufacturer and/or content host, etc.) and can be edited by the purchaser in a variety of ways that can depend on the embodiment (e.g., wherein some default content always remains, wherein the content is fully editable by the purchaser, etc.).

In certain embodiments, one or more parties (e.g., the manufacturer, etc.) can preemptively, or subsequently, transfer control of the machine-readable informational tag to a different entity. In such embodiments, such entity could be the one hosting, and controlling the content of, one or more additional parties. For example, a manufacturer could prepare QR codes that are linked to a purchaser's web domain for the purchaser to control and interact with additional parties. Subsequent transfers can be achieved by, for example, transferring rights associated with a first party's account to a second party's account, updating DNS records, transferring the web domain, or setting up a web redirect. In various such transfers, none of the content is associated with or controlled by the manufacturer, at least a subset of the content can be associated with or controlled by the manufacturer, or the transferee can control and/or regulate content or the lack thereof from the manufacturer in any of a variety of manners discussed herein (e.g., blocking or allowing content, selecting between one of a plurality of manufacturer content options provided by the manufacturer, etc.).

In some embodiments, to ensure quality and limit liability, the supplemental content can automatically be disabled in certain scenarios until reviewed (e.g., by the manufacturer or other entity acting as a primary party in connection with that content) or be automatically disabled after a predetermined period of time to ensure that out of date information is not being provided by secondary parties. In some embodiments, AI (artificial intelligence) systems and/or techniques such as machine learning or neural networks can be used to screen added content to attempt to prevent inappropriate content from being added. As one example, if an additional party is including content about their environmental efforts but has subsequently abandoned such efforts, the content can automatically be disabled after a certain period of time to prevent false marketing being attributed to the manufacturer. In certain embodiments, the number of times, or the duration of time when, supplemental content can be submitted can be controlled by a primary party.

In certain embodiments, the supplemental content can alternatively or additionally be provided as a link to a third-party website. In some such embodiments, a warning can be provided to the user upon clicking the link that the content hosted by the additional party is controlled and operated by the additional party and that the manufacturer/content host/etc. does not monitor or regulate such content. In certain such embodiments, the supplemental content can load in a sub-window on the same page.

Management of the supplemental content can vary. For example, in certain embodiments, the additional parties can contact a manufacturer/content host/etc. to include certain content. Such embodiments can include embodiments wherein the supplemental content will be relatively fixed and unchanging.

In yet other embodiments however, the supplemental content can be electronically controlled. In such embodiments, a unique access key can be provided to access management of the supplemental content. The unique access key can be provided with, or removably affixed to, the product including the machine-readable informational tag. In certain embodiments, the unique access key can be a password. In certain embodiments, the unique access key can be a unique link which automatically allows editing and submission of supplemental content. In the same or other embodiments, parties interacting with the content can have an account, profile, or access keys associated with the content, and one or more rights (e.g., which can be fixed or changeable, etc.) can be associated with the account/profile/access keys, such as: the ability to add content which can be or unrestricted or subject to one or more restrictions (e.g., selection of potential content, which can be predefined, defined via another party, etc.; adding content subject to regulation/control of another party; linking to or embedding externally generated and/or hosted content, which can be potentially subject to regulation/control, etc.); the ability to regulate or control content or proposed content from another party; the ability to transfer or grant rights to another party (e.g., equal to or lesser than those of the account/profile, etc.) or to any parties interacting with the article and/or content; etc. In the same or other embodiments, one or more such rights can be available to any party interacting with the content, regardless of whether they have or lack an account/profile/access keys that can be associated with the same or other rights.

In other embodiments, some or all of the supplemental content can be edited by anyone interacting with the tag. As can be appreciated, combinations of such access are also contemplated. For example, a first purchaser may have a greater ability to edit the supplemental content using a unique access key or account/profile and the general public would have limited ability to interact with or add supplemental content without such unique access key/account/profile. In some embodiments, a plurality of access keys/accounts/profiles can be created with varying levels of privilege.

Generally, both the primary (e.g., manufacturer-provided, etc.) content and the supplemental content created by additional parties can be managed in a database.

Machine-readable informational tags employed in or in connection with various embodiments discussed herein can be produced. For example, QR codes can be attached to (e.g., printed, machined, embossed, etc. on, or on a physical tag/sign/placard on any suitable article or device. Similarly, NFC tags and RFID tags can be manufactured and attached to (e.g., affixed to and/or housed within, etc.) physical article(s). Optionally, indicia can be provided on or near the article to indicate the presence of the machine-readable informational tags and/or that the machine-readable informational tags have enhanced content.

For ease of illustration, various example embodiments are discussed herein wherein the machine-readable informational tags comprise QR codes that link to an Internet website that hosts the content associated with the tag, wherein the content can be accessed by any party (e.g., wherein adding and/or editing content can be restricted to specific parties or available to the general public, depending on the embodiment). However, in various embodiments, other types of machine-readable informational tags (e.g., NFC, RFID, etc.) can be employed which can comprise the content, link to the content, or a combination thereof (e.g., with some content stored locally and other content stored remotely, local storage of information based on which remote content is selected, etc.). Additionally, in some embodiments, content not stored on or with a tag can be partially or entirely hosted on intranet(s), extranet(s), a website for which access to some or all of the content is restricted (e.g., to parties with an access key, account, profile, etc.), etc., instead of on a publicly accessible Internet website.

In various embodiments, a machine-readable informational tag as discussed herein can be associated with a physical article and content associated with at least one of the physical article and one or more parties, such as a manufacturer, a purchaser/donor, a recipient, a host, etc. In some embodiments, a single machine-readable informational tag, a single physical article, and a single collection of content (e.g., webpage, etc.) are associated with each other. In some such embodiments, the single tag can be affixed to the single physical article and can comprise and/or link to the single collection of content associated with that single physical article to uniquely associate the single collection of content with the physical article.

In one example scenario, there can be a plurality of physical articles (e.g., benches, planters, works of art, etc.), wherein each physical article has a single associated tag affixed to that physical article, and wherein each tag comprises or links to specific content (e.g., a webpage, etc.) associated with that physical article (e.g., each physical article of the plurality can have a unique tag affixed to that physical article, and each unique tag can link to a unique webpage which can comprise unique content and/or content shared by one or more other such webpages, etc.). Thus, in such scenarios, each unique physical article is associated with a unique tag (e.g., a unique QR code, etc.) that links to a unique website (or other content source, etc.) comprising content from two or more parties that relate in various ways to the physical article (e.g., manufacturer, donor, recipient, artist, owner, host, etc.). Such embodiments can be employed in a wide range of scenarios, including use cases where additional information or context is associated with the specific physical article that potentially involves multiple parties, such as a memorial or donated bench/planter/etc. (potentially involving one or more of a manufacturer, donor, recipient, honoree, etc.), works of art (potentially involving one or more of an artist, an owner/donor, a recipient/host, etc.), etc.

In various such embodiments, the content can be created and/or edited by two or more parties (e.g., a manufacturer of the physical article, a purchaser/donor of the physical article, a recipient/host of the physical article, one or more visitors to the physical article, etc.). In some of these embodiments, some or all of the two or more parties can generate content based on template(s) that can be associated with one or more physical articles associated with that party and/or modified for use in connection with one or more other physical articles. In some embodiments, content can be manually selected or automatically generated based on one or more characteristics of the physical article or one or more parties. For example, for a physical article at a fixed or known location, content can be based on the location and/or one or more parties, such as whether the location is in a specific region (e.g., a specific park, etc.) or within a specific distance of another location (e.g., a place of business of a party, etc.).

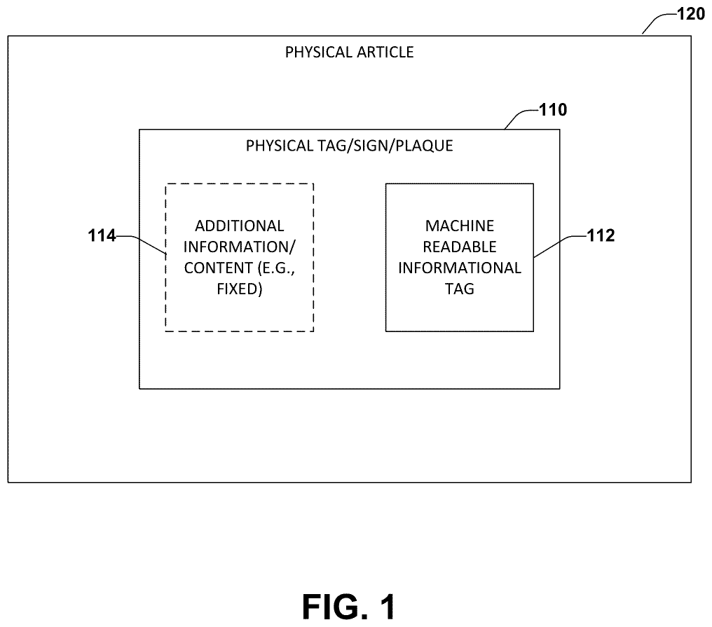

Referring to FIG. 1, illustrated is a diagram showing an example use case of a machine readable informational tag 112, according to various aspects discussed herein. A physical tag/sign/plaque/etc. 110 can be affixed to or otherwise associated with a physical article 120. The physical tag 110 can comprise tag 112 and optionally additional content or information 114. Additional information 114 can be, for example, text, images, logos, trademarks, etc. printed on physical tag 110 identifying and/or indicating information associated with one of the parties and/or the physical article (e.g., a message from one or more of the parties, a description of the physical article such as a name and indication of materials (e.g., recycled, etc.), a name of an artist who created/painted/etc. the article, a name/logo of a donor of the article, a name/logo recipient or host of the article, a dedication/memorial of person(s) in whose honor the article was created/donated/etc., and/or other information).

Machine readable informational tag 112 can comprise or link to digital content in a manner that depends on the type of tag (e.g., QR code, NFC, RFID, etc.) employed as tag 112. For ease of illustration, a QR code (e.g., printed, embossed, etched, etc. onto physical tag 110) linking to a website is discussed as an example embodiment of tag 112 herein, but other embodiments can be employed, such as those that would be apparent to a person of ordinary skill in the art in view of the disclosure herein.

In various embodiments, tag 112 can link to content on a website associated uniquely with physical article 120, and the content can be selected by two or more parties associated with that physical article. In such embodiments, a first tag associated with a first physical article can link to a first website, while a second tag associated with a second physical article that is different than the first physical article can link to a second website that is different than the first website, even when the first physical article and the second physical article are similar or identical (e.g., two different benches/shirts/planters/sculptures of the same design, etc.). This can allow parties to associate content uniquely with a given physical article (e.g., based on their relationship to or history with that physical article, etc.) without the limitations of existing signs or plaques (e.g., limited space for content, limited types of content, limited ability to change content, etc.) while still being able to provide the same benefits (e.g., indication of a donor, sponsor, memorialized honoree, etc. associated with a bench; indication of an artist, medium, owner, host, etc. of artwork; or any of a variety of other scenarios).

In general, the content associated with physical article 120 and linked to by tag 112 can be substantially any digital content selected by the relevant parties. In some embodiments, however, a party can generate one or more templates (e.g., wherein each template comprises a collection of content associated with the party) and can select a specific template of the one or more templates for each physical article 120. These templates can provide multiple advantages.

First, the use of templates as discussed herein can simplify the process of creating and presenting digital content on a webpage, making it more accessible for a variety of parties. Instead of a more open-ended process of webpage creation that requires a relatively high level of technical sophistication from a party, parties can select or generate content in connection with a plurality of well-defined categories (e.g., text, audiovisual content such as images, links, etc.), which can then be presented in a uniform manner.

Second, templates as discussed herein can allow for webpages to be dynamically created based on the templates associated with that webpage. For example, a first party can select a first set of content (e.g., text, audiovisual content, links, etc.) to be associated with a first template and a second party can select a second set of content to be associated with a second template. For a given website, the first party can select that its content will be generated from the first template and the second party can select that its content will be generated from the second template, thus the webpage can be generated to comprise content from the first template and content from the second template. Later, the first party can modify the first template (e.g., to add some content and/or remove some content) and the webpage can be updated automatically because it comprises the content from the first template, which has been modified. Additionally or alternatively, the second party can choose to change its content on the webpage by replacing the second template with a third template, and the webpage can be generated based on the content associated with the first template and the content associated with the second template.

Third, templates as discussed herein can allow for a party to easily select content to apply to a large number of physical articles. Some parties (e.g., manufacturers, purchasers and/or owners of a large number of physical articles, donors of a large number of physical articles, hosts of a large number of physical articles, etc.) can have a large number of websites associated with a large number of physical articles. In many scenarios they may want to provide content that is the same or overlapping to various websites. For example, a party might want to provide identical content to associate with some or all physical articles meeting one or more criteria (e.g., to all articles, to all articles within a geographic region, to all articles of a given product type, etc.), and can do so by associating those articles (e.g., selected individually or based on the criteria, etc.) with a common template. As another example, for a given party a first portion of its content (e.g., describing the party, its mission or goals, social media links, links to websites managed by the party, etc.) might remain fixed across many or all websites created in connection with embodiments discussed herein, and once associated with a first template, can be used as a basis for readily creating additional templates.

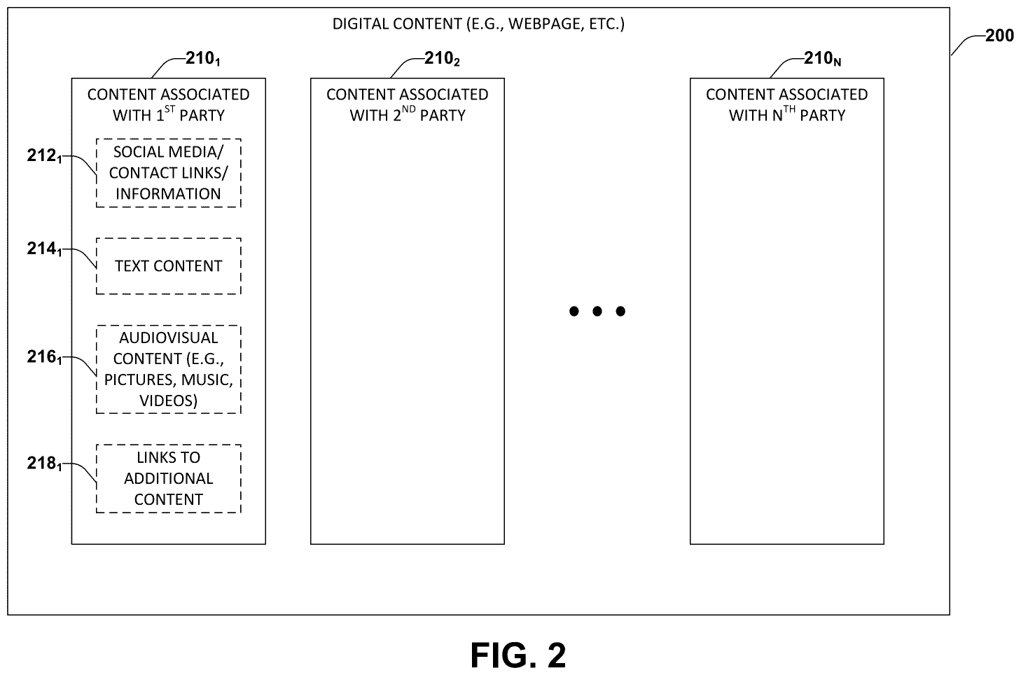

Referring to FIG. 2, illustrated is a first example website 200 generated based on content from two or more parties, according to various aspects discussed herein. For website 200, each of N parties can select their own content 210₁-210_{N} to provide on website 200, which can be uniquely associated with a specific physical article. In various embodiments, this content can include any of a variety of types of content, such as social media and/or contact links/information 212ᵢ, text content 214ᵢ (e.g., which can include a name of the party, a description of the party and/or its goals, etc.), audiovisual content 216ᵢ (e.g., pictures, music, videos, colors and/or designs, etc.), links to additional (e.g., external to the website, etc.) content 218ᵢ (e.g., for a corporation this might include a corporate webpage and/or subpages such as product pages, a recruitment page, pages discussing charitable projects by the company, etc.; for family and/or friends who have donated a memorial, these pages might relate to interests of the deceased, charities, etc.). In various embodiments, links to additional content 218ᵢ can be displayed in a consistent manner, for example, with a name (e.g., determined by the party, etc.) and image (e.g., sized to uniform dimensions among links, etc.) that can be interacted with (e.g., clicked, etc.) to access the linked content. In various embodiments, the content 210ᵢ can be presented in content cards containing all of the selected content of each party arranged in a similar manner for the various parties. In some embodiments, this content can be selected automatically, manually, and/or manually based on automatically suggested content (e.g., based on characteristics of the physical article such as location or product type, based on other templates for the same party/product/location/etc.). In various embodiments, one or more links 218ᵢ can be presented in a uniform manner, such as with a name and photograph selected by the party and can be arranged in a similar manner across templates (e.g., tiled, in a list, etc.) and/or websites, which can provide a uniform feel to the interface for various webpages for multiple physical articles and their associated tags.

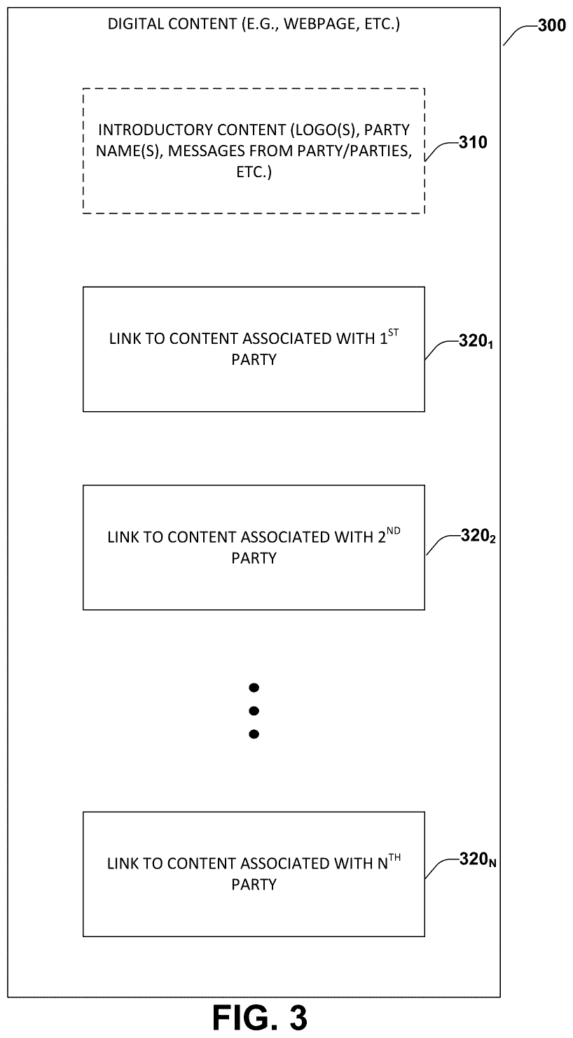

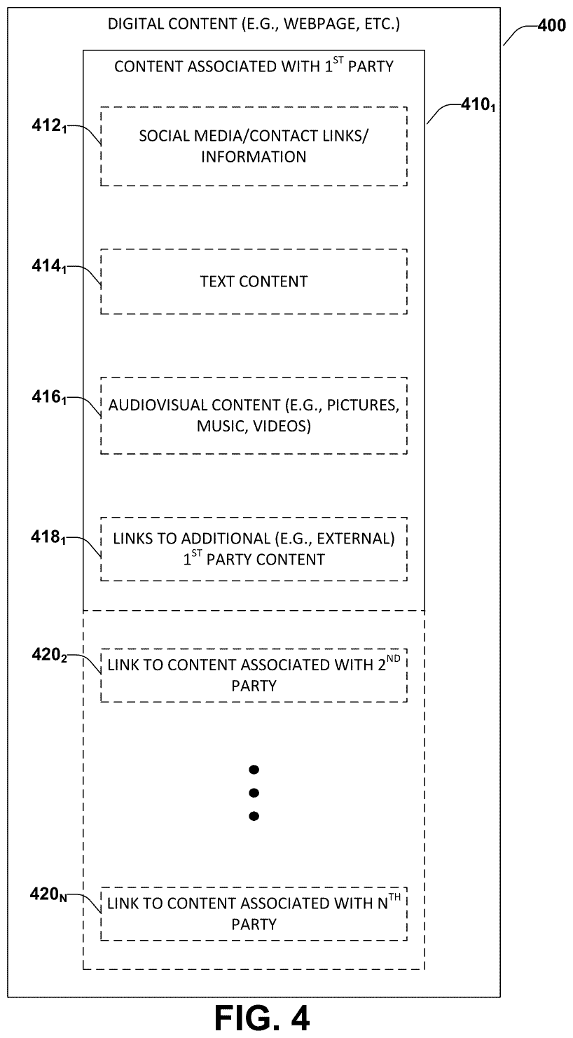

Referring to FIG. 3, illustrated is a second example website 300 generated based on content from two or more parties, according to various aspects discussed herein. Website 300 can comprise a more compact presentation of content associated with the parties than website 200. Website 300 can optionally comprise introductory content 310, which can include a logo and/or party name for one or more parties (e.g., a donor, etc.), text (e.g., a message providing context/information regarding the physical article and/or one or more parties; a message from the party in connection with the physical article and/or the parties values/contributions/etc.; a message from family/friends of a person in whose honor the article was donated; etc.). Additionally, website 300 can comprise two or more links 310ᵢ (e.g., which can be presented in a uniform manner, such as with party name and a photograph, etc.) to content from two or more parties associated with the physical article. In various embodiments, the content from parties associated with the physical article that is linked to can be presented in a content card similarly to that of content 210ᵢ of FIG. 2 or content 410₁ of FIG. 4, discussed below.

Referring to FIG. 4, illustrated is a third example website 400 generated based on content from two or more parties, according to various aspects discussed herein. Website 400 can comprise content associated with a first party 410ᵢ, which can be similar to content 210₁ (e.g., comprising similar types of potential content, potentially also arranged in a uniform manner across multiple websites associated with distinct physical articles, etc.), but website 400 can additionally comprise links to content from one or more additional parties associated with the physical article (e.g., manufacturer, content host, recipient, etc.) that can be presented in a content card similarly to that of content 210ᵢ of FIG. 2 or content 410₁ of FIG. 4. In some embodiments, these links can be presented in the same content card as content 410₁ (as indicated by the extended dashed region below content 410₁), while in others they can be presented separately below content 410₁.

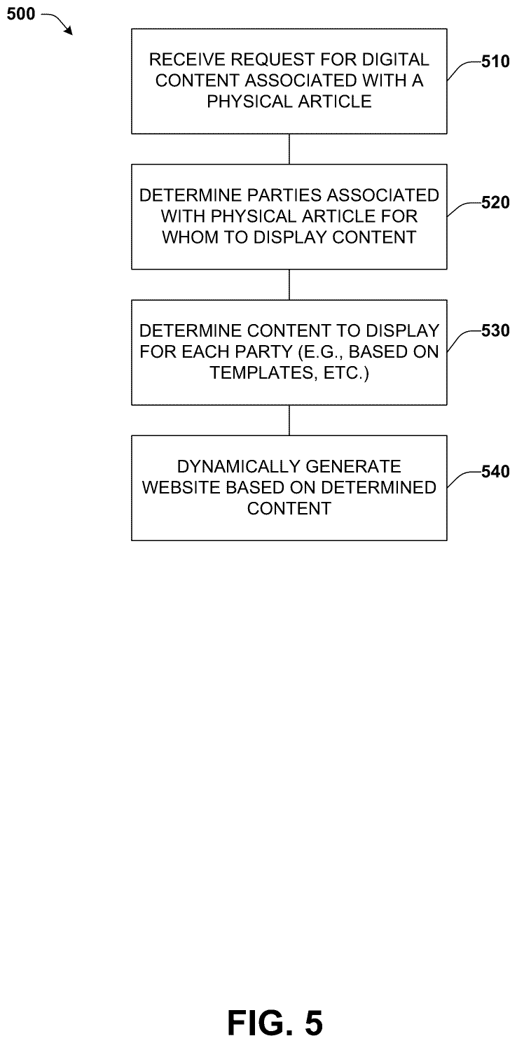

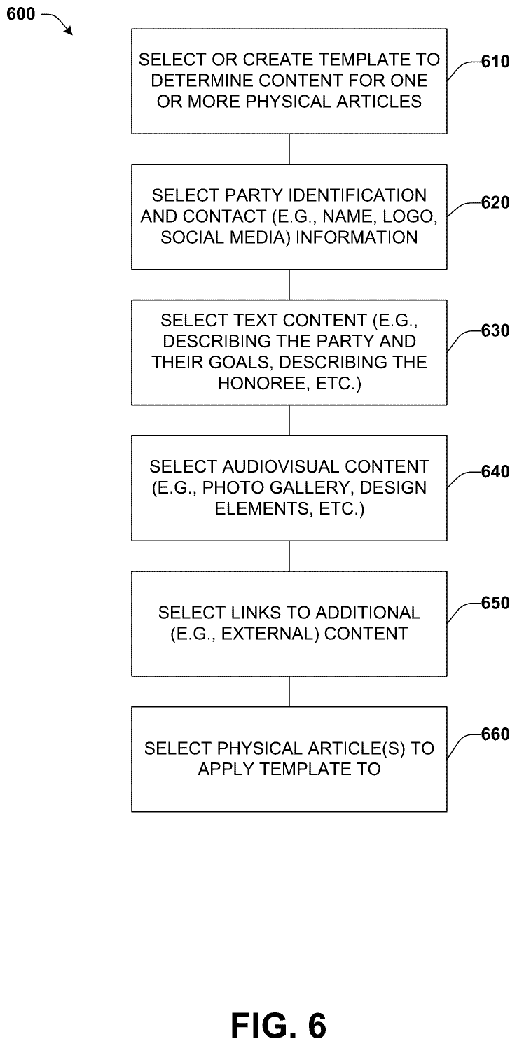

In view of the exemplary diagrams described above, process methods that can be implemented in accordance with the disclosed subject matter will be better appreciated with reference to the flow charts of FIGS. 5 and 6. While for purposes of simplicity of explanation, the methods of FIGS. 5 and 6 are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein, and in some embodiments additional steps known in the art or reasonably conveyed to one of ordinary skill in the art by way of the context provided herein are also considered within the scope of the present disclosure. Moreover, some steps illustrated as part of one process can be implemented for another process where suitable; other steps of one or more processes can be added or substituted in other processes disclosed herein within the scope of the present disclosure. Additionally, it should be further appreciated that the methods disclosed throughout this specification are capable of being stored on an article of manufacture to facilitate transporting and transferring such methodologies to an electronic device. The term article of manufacture, as used, is intended to encompass a computer program accessible from any computer-readable device, device in conjunction with a carrier, or storage medium.

Referring to FIG. 5, illustrated is a flow diagram of an example method or process 500 of dynamically generating digital content from multiple parties in connection with a specific physical article, according to various aspects discussed herein. In other aspects, a machine readable (e.g., computer-readable, etc.) medium can store instructions associated with method 500 that, when executed, can cause a machine (e.g., computer, mobile device, etc.) to perform the acts of method 500.

At 510, method 500 can comprise receiving a request for digital content associated with a specific physical article. In various embodiments, the specific physical article can be associated with a specific website, etc. associated solely with the specific physical article and parties related to the specific physical article.

At 520, method 500 can comprise determining one or more parties associated with the physical article that content will be generated in connection with. For example, a memorial bench might have associated content from one or more of: a family of the deceased, a manufacturer of the bench, a recipient (e.g., a city or park, etc.) of the bench, a digital content host, etc.

At 530, method 500 can comprise determining associated content to display in connection with the specific physical article for each of the parties determined at 520. In some embodiments, this can involve determining an associated template for each of those parties and content referenced by the associated template(s). This content can comprise any of the types of content discussed herein, and can be arranged in a variety of ways, including the examples discussed herein.

At 540, the website can be dynamically generated based on the determined content. Because the content can be determined and generated in response to the request based on the associated parties and their selected content (e.g., via templates as discussed herein, etc.), the content can be readily changed or updated (e.g., by updating the content indicated by the template, etc.).

Referring to FIG. 6, illustrated is a flow diagram of an example method or process 600 of selecting or editing digital content for a template to associate with one or more physical article(s), according to various aspects discussed herein. In other aspects, a machine readable (e.g., computer-readable, etc.) medium can store instructions associated with method 600 that, when executed, can cause a machine (e.g., computer, mobile device, etc.) to perform the acts of method 600. In various embodiments, method 600 can involve creation of a template and application of the template to one or more physical articles. However, in other embodiments, method 600 can be employed to edit an existing template.

At 610, method 600 can comprise selecting a template (e.g., an existing template or a new template) for use in associating digital content with one or more specific physical articles. For a party creating a new template that has one or more existing templates, one of the existing templates can be selected as a basis for creating the new template.

At 620, method 600 can comprise selecting information associated with identification and contact of the party (e.g., name, description, logo, social media accounts, etc.).

At 630, method 600 can comprise selecting text content to present in connection with the one or more physical articles. The type of message can depend on the party and/or use case; for example, in connection with a donated physical article it could be a message of kindness explaining more about the party and their charitable efforts (e.g., in general, in connection with the community, etc.), about the deceased and their interests, etc.

At 640, method 600 can comprise selecting audiovisual content to present in connection with the one or more physical articles. The type of content can vary (e.g., photo gallery or slideshow, background color and/or pattern, video, sounds/music, etc.) and can be selected based on previously used content by the party creating the template and/or additional content added for the template.

At 650, method 600 can comprise selecting one or more links to additional (e.g., external to the website, etc.) content. Depending on the party and their goals, these might be a corporate website or portions thereof, a city and/or park website, programs or charities the party selects, interests of a deceased in connection with a memorial donation, etc. In some embodiments, the selected links can be presented in a uniform manner and with associated content, for example, each link can be presented along with a short text description and an associated image in a uniform manner across the template and/or across a plurality of templates.

At 660, method 600 can comprise selecting one or more physical articles to which the template is to apply. In some cases, this might be a single physical article, for example, because the party is associated with relatively few physical articles, because the physical article has unique characteristics (e.g., it is a specific work of art, etc.), etc. In other cases, the template could apply to a relatively large number of physical articles, for example, content by a manufacturer might be consistent across a product line, while content from other parties may vary for those same products based on other criteria (e.g., varying donors, recipients, locations, etc.). In some cases, a specific unique template can be generated for a physical article based on modification of a more commonly used template. For example, if a physical article (e.g., bench and/or planter, etc.) from a given product line (e.g., benches and/or planters comprising repurposed portions of windmill blades and recycled materials, etc.) is modified to become unique (e.g., via an artist painting the bench and/or planter with a unique work of art, etc.), a unique template can be applied to that physical article that can be similar to but distinct from a more general template applied to other physical articles of the same product line.

The type of content selected in connection with various steps or acts of method 600 can be one of: manually selected, automatically selected based on one or more criteria (e.g., location, product type, etc., including based on content of other templates sharing one or more criteria with the current template), manually selected based on automatically generated suggestions, etc. For example, with physical articles having fixed locations (e.g., benches, planters, larger sculptures, etc.), the location can be geotagged and associated with the unique physical article for use in connection with selecting, suggesting, or generating digital content. Additionally or alternatively, various other characteristics can be associated with physical articles (e.g., product type, etc.) which can be used in connection with selecting, suggesting, or generating digital content.

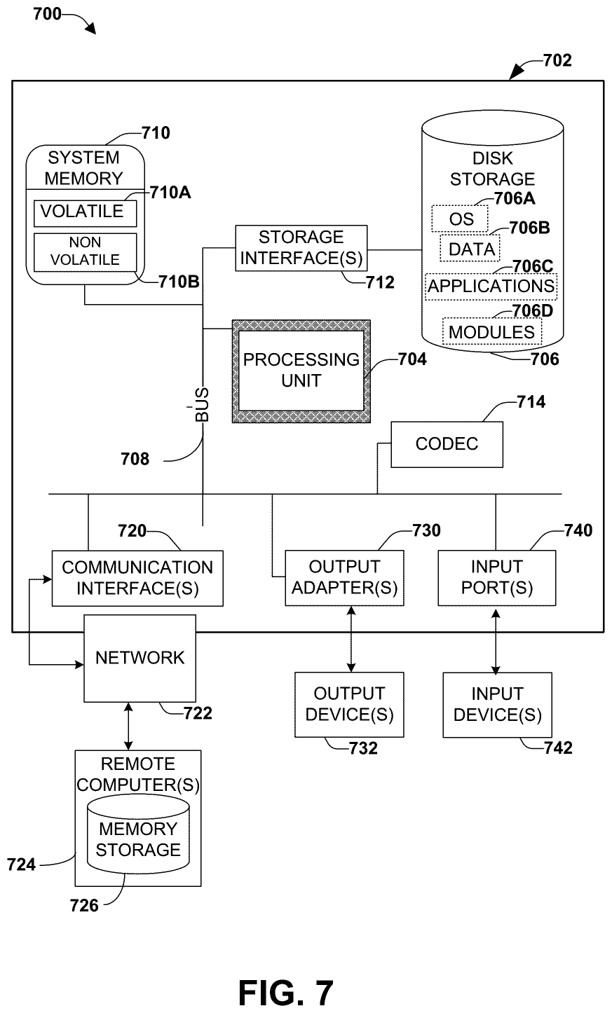

In connection with FIG. 7, the systems and processes described herein can be embodied within hardware, such as a single integrated circuit (IC) chip, multiple ICs, an application specific integrated circuit (ASIC), or the like. A suitable operating environment 700 for implementing various aspects of the claimed subject matter includes a computer 702.

The computer 702 includes a processing unit 704, a system memory 710, a codec 714, and a system bus 708. The system bus 708 couples system components including, but not limited to, the system memory 710 to the processing unit 704. The processing unit 704 can be any of various available processors. Dual microprocessors and other multiprocessor architectures also can be employed as the processing unit 704.

The system bus 708 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 710 can include volatile memory 710A, non-volatile memory 510B, or both. Functions of systems and methods described in the present specification can be programmed to system memory 710, in various embodiments. The basic input/output system (BIOS), containing the basic routines to transfer information between elements within the computer 702, such as during start-up, is stored in non-volatile memory 710B. In addition, according to present innovations, codec 714 may include at least one of an encoder or decoder, wherein the at least one of an encoder or decoder may consist of hardware, software, or a combination of hardware and software. Although, codec 714 is depicted as a separate component, codec 714 may be contained within non-volatile memory 710B. By way of illustration, and not limitation, non-volatile memory 710B can include read only memory (ROM), programmable ROM (PROM), electrically programmable ROM (EPROM), electrically erasable programmable ROM (EEPROM), or Flash memory. Non-volatile memory 710B can be embedded memory (e.g., physically integrated with computer 702 or a mainboard thereof), or removable memory. Examples of suitable removable memory can include a secure digital (SD) card, a compact Flash (CF) card, a universal serial bus (USB) memory stick, or the like. Volatile memory 710A includes random access memory (RAM), which can serve as operational system memory for applications executed by processing unit 704. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM), and so forth.

Computer 702 may also include removable/non-removable, volatile/non-volatile computer storage medium. FIG. 7 illustrates, for example, disk storage 706. Disk storage 706 includes, but is not limited to, devices such as a magnetic disk drive, solid state disk (SSD) floppy disk drive, tape drive, Flash memory card, memory stick, or the like. In addition, disk storage 706 can include storage medium separately or in combination with other storage medium including, but not limited to, an optical disk drive such as a compact disk ROM device (CD-ROM) or derivative technology (e.g., CD-R Drive, CD-RW Drive, DVD-ROM, and so forth). To facilitate connection of the disk storage 706 to the system bus 708, a removable or non-removable interface is typically used, such as interface 712.

It is to be appreciated that FIG. 7 describes software that can program computer 702 to perform acts described herein within operating environment 700. Such software includes an operating system 706A. Operating system 706A, which can be stored on disk storage 706, acts to control and allocate resources of the computer 702. Applications 706C take advantage of the management of resources by operating system 706A through program modules 706D, and program data 706B, such as the boot/shutdown transaction table and the like, stored either in system memory 710 or on disk storage 706. It is to be appreciated that the claimed subject matter can be implemented with various operating systems or combinations of operating systems.

Input device(s) 742 connects to the processing unit 704 and facilitates user interaction with operating environment 700 through the system bus 708 via interface port(s) 730. Input port(s) 740 can include, for example, a serial port, a parallel port, a game port, a universal serial bus (USB), among others. Output device(s) 732 use some of the same type of ports as input device(s) 742. Thus, for example, a USB port may be used to provide input to computer 702 and to output information from computer 702 to an output device 732. Output adapter 730 is provided to illustrate that there are some output devices, such as graphic display, speakers, and printers, among other output devices, which require special adapters. The output adapter 730 can include, by way of illustration and not limitation, video and sound cards that provide a means of connection between the output device 732 and the system bus 708. It should be noted that other devices or systems of devices provide both input and output capabilities such as remote computer(s) 724 and memory storage 726.

Communication connection(s) 720 refers to the hardware/software employed to connect the network interface 722 to the system bus 708. While communication connection 720 is shown for illustrative clarity inside computer 702, it can also be external to computer 702. The hardware/software necessary for connection to the network interface 722 includes, for exemplary purposes only, internal and external technologies such as, modems including regular telephone grade modems, cable modems and DSL modems, ISDN adapters, and wired and wireless Ethernet cards, hubs, and routers.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. The block diagrams of the architecture and flow charts are grouped for ease of understanding. However, it should be understood that combinations of blocks, additions of new blocks, re-arrangement of blocks, and the like are contemplated in alternative embodiments of the present disclosure.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A non-transitory machine readable medium, comprising instructions, wherein the instructions, when executed, cause a machine to:
receive a request for digital content, wherein the digital content is uniquely associated with a physical article;
determine one or more parties associated with the physical article;
for each party of the one or more parties, determine associated content for that party for the physical article; and
dynamically generate the digital content for the physical article based on the associated content determined for each party of the one or more parties.

2. The non-transitory machine readable medium of claim 1, wherein the one or more parties are two or more parties.

3. The non-transitory machine readable medium of claim 1, wherein the digital content is uniquely associated with a machine readable informational tag that is uniquely associated with the physical article.

4. The non-transitory machine readable medium of claim 3, wherein the machine readable informational tag comprises a quick response (QR) code that is uniquely associated with the digital content and uniquely associated with the physical article.

5. The non-transitory machine readable medium of claim 1, wherein the digital content comprises a webpage.

6. The non-transitory machine readable medium of claim 1, wherein for each party of the one or more parties, the associated content for that party for the physical article is determined based on an associated template for that party for the physical article.

7. The non-transitory machine readable medium of claim 1, wherein for each party of the one or more parties, the associated content for that party comprises text content.

8. The non-transitory machine readable medium of claim 1, wherein for each party of the one or more parties, the associated content for that party comprises audiovisual content.

9. The non-transitory machine readable medium of claim 1, wherein for each party of the one or more parties, the associated content for that party comprises one or more links to additional content associated with that party.

10. A system, comprising:
a physical article; and
a physical tag associated with and proximate to the physical article, wherein the physical tag comprises a machine readable informational tag that uniquely associates digital content solely with the physical article, wherein the digital content comprises associated content from one or more parties associated with the physical article.

11. The system of claim 10, wherein the physical tag is affixed to the physical article.

12. The system of claim 10, wherein the physical tag comprises non-digital content associated with one or more of the physical article or at least one of the one or more parties.

13. The system of claim 10, wherein the machine readable informational tag comprises a quick response (QR) code that is uniquely associated with the digital content and uniquely associated with the physical article.

14. The system of claim 13, wherein the digital content comprises a webpage and wherein the QR code links to the webpage.

15. The system of claim 10, wherein the physical article has a fixed location.

16. The system of claim 15, wherein the digital content is based at least in part on the fixed location.

17. A system, comprising:
a memory configured to store instructions; and
one or more processors configured to execute the instructions to:
select a template to determine digital content for a party in connection with one or more physical articles;
select at least one of identification information or contact information for the party, wherein the digital content comprises the at least one of the identification information or the contact information;
select text content associated with the party, wherein the digital content comprises the text content;
select audiovisual content associated with the party, wherein the digital content comprises the audiovisual content;
select one or more links to additional content associated with the party, wherein the digital content comprises the one or more links to additional content; and
select the one or more physical articles for which the template is applied,
wherein, for each physical article of the one or more physical articles, the template is applied to a unique website associated solely with that physical article.

18. The system of claim 17, wherein the one or more processors being configured to select the template comprises the one or more processors being configured to create the template.

19. The system of claim 17, wherein at least a subset of the digital content is one of selected or suggested to a user based at least in part on a common characteristic of the one or more physical articles.

20. The system of claim 17, wherein, for each physical article of the one or more physical articles, the, unique website associated solely with that physical article is accessible via a machine readable informational tag associated with that physical article.
